(19) United States
(12) Patent Application Publication
(10) Pub. No.: US 2009/0327035 A1
(43) Pub. Date: Dec. 31, 2009

(54) MEDIA CONTENT SERVICE FOR RENTING JUKEBOXES AND PLAYLISTS ADAPTED FOR PERSONAL MEDIA PLAYERS

(75) Inventor: James E. Allard, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/164,028

(22) Filed: Jun. 28, 2008

(51) Int. Cl. G06Q 30/00; G06F 17/00; G06F 15/16

(52) U.S. Cl. 705/10; 707/104.1; 709/217; 705/27; 707/E17.009; 707/E17.005

(57) ABSTRACT

An online media content service is adapted for use with a personal media player to provide targeted content to the player on a rental basis and is architected to enable users to access music using new models.. The targeted media content includes content that has special context or meaning to a user of the service by virtue, for example, of either being organized into a collection that appeals to the user, or by being related to the user through the user's social graph. In the first case, the targeted media content may illustratively include a set of media that has been selected to fulfill a theme or genre, and is made available to a user as a package to access and play for a limited period of time for a rental fee. In the second case, the targeted media content may illustratively include a collection of songs that are drawn from playlists of people that the service knows to be friends of the user and provided on a subscription basis.

### BACKGROUND

Personal media players and other battery powered portable electronic devices that can play digital media content including that in the popular MP3 (Moving Pictures Expert Group, MPEG-1, audio layer 3) format have made it easy for users to enjoy media content wherever and whenever they want. Such players commonly have very large storage capacities that can hold large libraries of media content including music, video, and pictures in a small and convenient package.

In addition to being able to transfer media content from traditional physical media such as CD (Compact Disc) to their players, many users take advantage of online content delivery services from which they can conveniently browse, select, and then download content from a web site to their personal computers (“PCs”) over the Internet. The media content can be downloaded using a variety of different business models including per-download charges, subscription based plans, advertising-supported models, or by using a combination of models.

While online access to media content has dramatically changed the way users can access and consume content, it does not always meet every need or expectation. Current music distribution architectures provide either single song purchase options or monthly subscription fees that provide access to the service's entire library. However, monthly subscription fee-based services have not gained in popularity due to their cost and also due to fears of the listener in not being able to retain content if the subscription is discontinued.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

An online media content service is adapted for use with a personal media player to provide targeted content to the player on a rental basis and is architected to enable users to access music using new models. The targeted media content includes content that has special context or meaning to a user of the service by virtue, for example, of either being organized into a collection that appeals to the subscriber, or by being related to the subscriber through the user's social graph (i.e., the network of connections and relationships among people using the service including friends of the user, and friends of friends, etc.). In the first case, the targeted media content may illustratively include a set of media that has been selected to fulfill a theme or genre, and is made available to a user as a package to access and play for a limited period of time for a rental fee. In the second case, the targeted media content may illustratively include a collection of songs that are drawn from one or more playlists of people that the service knows to be friends of the user and provided on a subscription basis.

In various illustrative examples, the online media content service is accessed from a personal computer over a network such as the Internet. The user of the service can access a web-based portal by which various pre-packaged collections of media content such as music and video may be browsed and selected for download and later consumption, typically on a rental basis. Each collection creates a virtual jukebox in which the media content is typically related. For example, the media content may be related by genre (e.g., rock, country, gospel, folk) or time period (music from the '60s, '70s, etc.). In addition, available virtual jukeboxes may have a tie-in to particular individuals or institutions, such as celebrities, sports teams, famous night clubs, or brands so that the collected media content can bring a sense of style, fashion, trend, or culture to the user's experience.

In addition to browsing pre-packaged jukeboxes, the user can also browse and select for download, typically on a rental basis, targeted media content that is customized by the media content service to the user. By collecting data such as profile data or usage statistics from the user, and from other users who can be designated as friends, the media content service can assemble targeted media content such as a playlist from a friend or one that is compiled from playlists from a group of friends.

After targeted content is selected and downloaded by the user to the PC, the content can be transferred to a personal media player through a synchronization process. This process may typically be performed using either a wired or wireless connection between the personal media player and the PC. Once transferred, the media content can be rendered by the player subject to some restrictions. The restrictions may be time or play count based. For example, a jukebox of 100 songs or a friend's playlist of 10 music videos might be playable over a weekend. Rich metadata may also accompany the targeted content in some implementations (e.g., album cover artwork; artist information; concert information and news from live feeds; reviews by other users or friends; “bonus,” “box set,” or “extras” features; etc.) to further enhance the user's experience with the targeted content.

Advantageously, the present media content service makes it easy for user to discover content that they will like. By targeting content having particular context or meaning to the user, the experience in consuming the content will often be more enjoyable. And, as the targeted content is provided on a rental or subscription basis where the fee charged is typically small, the user can experiment with new experiences with little risk. In addition, new models of purchasing may be created as users may desire to rent a set of songs for a specific event. Such desires are not met by any current purchasing models.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative personal media player usage environment;

FIG. 2 shows an illustrative personal media player that is inserted into a dock for synchronization with a PC;

FIG. 3 shows an illustrative flow of targeted content from a service to a PC and a personal media player;

FIG. 4 shows a set of illustrative components that are used to implement the media content service;

FIG. 5 shows details of the programming of media content into virtual jukeboxes; and

FIG. 6 shows details of the programming of media content into playlists.

Like reference numerals indicate like elements in the drawings. Elements are not drawn to scale unless otherwise indicated.

### DETAILED DESCRIPTION

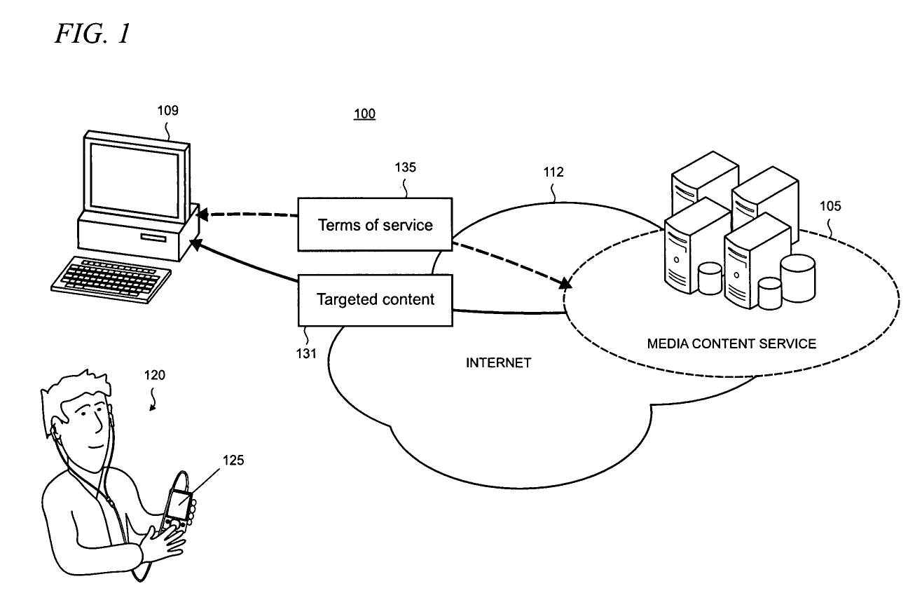

FIG. 1 shows an illustrative environment 100 in which the present media content service may be practiced. A media content service 105 is arranged as a cloud-based service that may be accessed from an internet accessible device such as PC 109 via public networks such as the Internet 112. PC 109 is commonly located in a home or office which a user 120 can utilize to store, organize, access, and render various types of media content in digital form. Such content commonly includes, for example, music, audio books, podcasts, images like photographs, video in the form of television programs, movies, music videos, and the like. As shown in FIG. 1, user 120 also uses a personal media player 125 that is typically arranged to render most types of media content when the user is away from the PC 109 but could also be used to directly access the Internet 112.

Personal media player 125 is representative of the variety of portable electronic devices that are available that can play audio, video, or both, including MP3 players, portable multimedia players, pocket PCs, smart phones, mobile phones, handheld game devices, personal digital assistants (“PDAs”), or other types of electronic devices that can store and render media content. And while a PC 109 is shown in the illustrative environment 100 in FIG. 1, other devices may also be used to access the media content service 105 such as laptop and handheld computers, multimedia centers, game consoles, set-top boxes, network devices such as servers and access points, and the like. In addition, while both audio and video are commonly consumed, and devices are often configured to render both, the present arrangement for media content programming may be arranged to work with either audio or video, or both audio and video as may be needed by a particular implementation, such as other types of media such as pictures, art, etc.

As described more fully below, the media content service 105 provides targeted content 131, comprising playlists or virtual jukeboxes to the user 120, which is subject to terms of service as indicated in FIG. 1 by reference numeral 135. That is, the user 120 must agree to abide to certain terms as a condition for using the service 105 such as usage rules, age requirements, and the like. While they can vary, terms of service are commonly utilized whether the service to which they apply is free to the user, or is provided on a fee basis. In this example, among other terms and conditions, the terms of service cover rental or subscription fees for the targeted content.

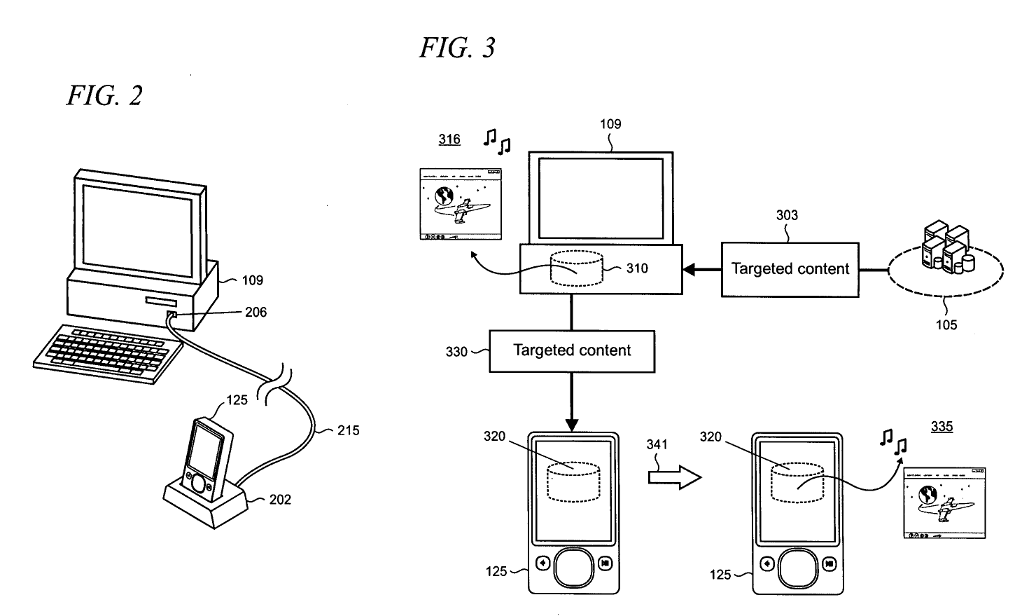

In this example, the personal media player 125 is arranged to be operatively couplable with the PC 109 using a host-client synchronization process by which data may be exchanged or shared between the devices. FIG. 2 shows the personal media player 125 as typically inserted into a dock 202 for synchronization with the PC 109. Dock 202 is coupled to an input port 206 such as a USB (Universal Serial Bus) port with a synchronization (“sync”) cable 215, in this example. In alternative arrangements, the personal media player 125 may be coupled directly to the sync cable 215 without using the dock 202. In addition, other arrangements may also be used to implement communications between the personal media player 125 and PC 109 including, for example, those employing wireless protocols such as Bluetooth, or Wi-Fi (i.e., the Institute of Electrical and Electronics Engineers, IEEE 802.11 standards family).

As shown in FIG. 3, targeted content 303 is provided by the service 105 to the PC 109. In one example, the targeted content 303 from the service 105 is stored to a persistent storage medium such as a hard disk 310. The targeted content can then be rendered by the PC 109 off the hard disk 310 so that content such as music and/or videos (collectively indicated by reference numeral 316) can be played and enjoyed by the user 120.

Another way that the user 120 can consume the targeted content 303 is by transferring the content from the PC 109 into a persistent store 320 that is utilized in the personal media player 125. The transferred targeted content 330 is then available so that programming such as music and/or videos (collectively indicated by reference numeral 335) can be rendered out of the store 320 when the personal media player 125 is disconnected from the PC 109 (as indicated by arrow 341) and used as a standalone device.

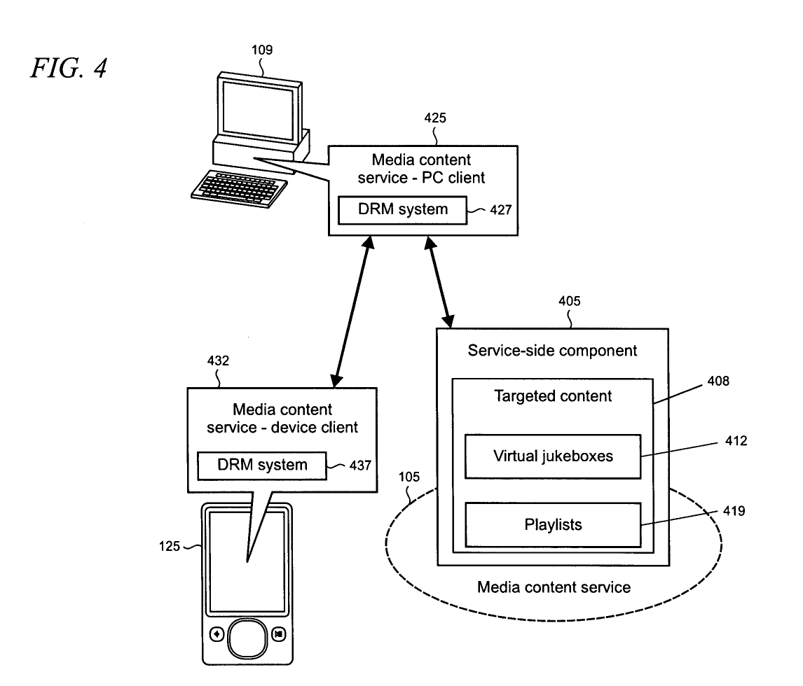

FIG. 4 shows a set of illustrative components that are used to implement the media content service 105. A service-side component 405 is provided to enable the user 120 to browse, select, and then download the targeted content 408. The targeted content 408, in this example, includes virtual jukeboxes 412 and playlists 419. The service-side component 405 is configured to interface with respective client-side components 425 and 432 on the PC 109 and portable media player 125.

The client-side components 425 and 432 on the PC 109 and portable media player 125, respectively, are configured to locally implement the various features and functionalities provided by the service 105. For example, the client-side PC component 425 may be arranged to interact with the service 105 to receive the targeted content 408 and store it on the hard disk 310 (FIG. 3), as well as provide a user interface with which, for example, the user may interact with the content, or set global preferences to be used by the service 105. This user interface may be implemented as an application, or be configured as an API (application programming interface), for example, to interface with other applications that may be running on the PC 109.

The client-side PC component 425 may also be configured to monitor user activities as it interacts with their media content programming for purposes of collecting user-feedback, as well as enforce the terms of service 135 (FIG. 1). The enforcement will typically be implemented using a DRM (digital rights management) system 427 that is instantiated on the PC 109 by the client-side PC component 425. The client-side PC component 425 may be further arranged to interact with the client-side device component 432 to effectuate transfer of the targeted content 330 (FIG. 3) from the PC 109 to the personal media player 125.

In addition to providing the functionality attendant to the transfer and storage of the targeted content, the client-side PC component 425 will typically provide control and user interface functions to enable the user 120 to render and interact with the targeted content on the personal media player 125. These controls and interface functions may be implemented using an interface or API to components which support existing user interface and controls (e.g., buttons and display screen) that are supported by the personal media player 125. Monitoring, feedback collection, and enforcement of terms of service are also typical functionalities that are implemented on the client-side device component 432 through a DRM system 437 that will typically work in concert with the corresponding DRM system 427 on the PC 109.

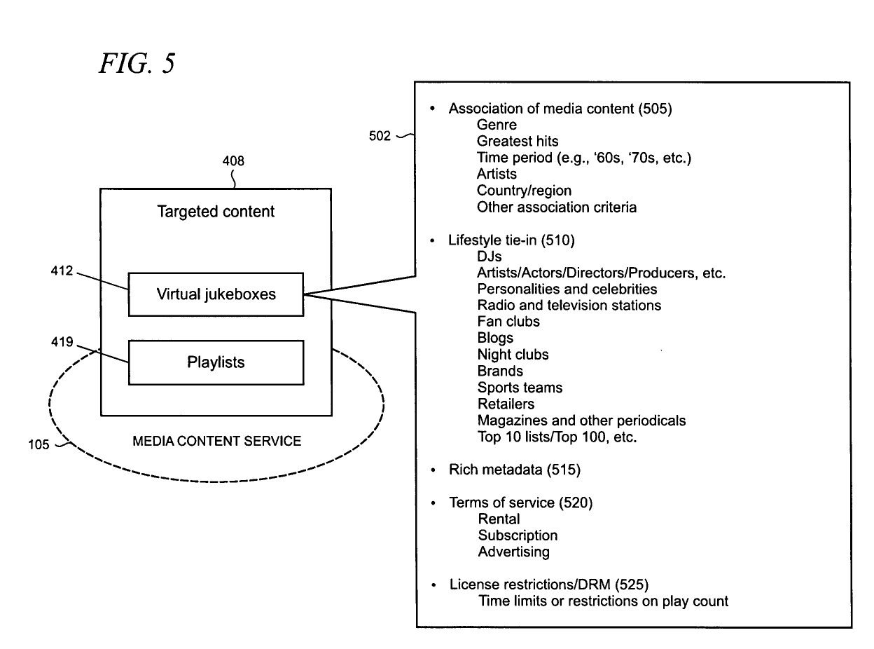

Turning now to FIG. 5, the media content service 105 is described in more detail. As indicated by reference numeral 502, a variety of factors may be considered and utilized to create targeted content 408 in the form of virtual jukeboxes 412. It is emphasized that the factors 502 are illustrative, they can be weighted in different ways, and other factors may also be utilized as required to meet the needs of a particular application, and to provide a selection of virtual jukeboxes to users that are suited to a variety of different tastes. In addition, it is not necessary that all the factors shown in FIG. 5 be used in all implementations of the present media content service.

In one illustrative example, the factors 502 will be utilized and weighted by a selection algorithm that is configured to operate in an automated manner by the service 105. In alternative arrangements, the algorithm may be configured to be manually adjusted or tuned to produce a particular result. The balance between automated and manual selection may be varied to meet the requirements of a particular implementation.

Particular pieces of media content may be associated into a virtual jukebox (as indicated by reference numeral 505) by taking into various attributes of the content that can be used for grouping purposes. These include attributes such as genre of the content. For music, this could include, rock, jazz, gospel, etc., and for video, typical genres include science fiction, epic drama, sports, mystery, action, etc. The popularity of media content such as collections of greatest hits of one or more artists may also be used to create a virtual jukebox. Similarly, media content may be grouped into a virtual jukebox by artist, country or region of content origin, and other appropriate association criteria.

Grouping media content into virtual jukeboxes in view of a lifestyle tie-in 510 is also contemplated. Here, persons or institutions known to influence and shape consumer lifestyle can be utilized to bring a sense of style, fashion, trend, or culture to the user's experience when the user selects, downloads, and then renders a virtual jukebox. So, for example, a noted DJ may put together a collection of personal favorite songs in virtual jukebox which is thus given the DJ's imprimatur or endorsement. Similarly, virtual jukeboxes can be tied-in with actors, personalities, magazines, fan clubs, sport teams, “top 10” lists, and so on. Users often strongly identify with such people, institutions, and constructs, and a virtual jukebox having a tie-in with them can be expected to be attractive. It is emphasized that the list indicated by reference numeral 510 is only illustrative and is not intended to be exhaustive. Other types of tie-ins that have special meaning or can elicit emotive responses from users may also be utilized to meet the requirements of a particular implementation.

Access to rich metadata is also provided in the user experience, as indicated by reference numeral 515. In this case, the user 120 is provided with an option to see and interact with a variety of information that is related to a particular piece of media content. For example, as a song in the virtual jukebox plays, the user 120 may operate the user interface on the PC 109 or personal media player 125 to look at the artwork for the song's album, read a biography of the artist or band performing the song, read the lyrics and liner notes, and see the artist's discography. The user 120 might also read reviews of the song, album, and/or artist from other users of the service 105, from friends on the service, or from professional reviewers and critics that write for contemporary magazines or blogs. Similar kinds of information can also be viewed for video content.

Other features of the type and kind that are often packaged with special editions of music or videos as “extra” or “bonus” features, or that are retailed as “box sets” can also be supported in the accessible rich metadata. These can include, for example, interviews with the artists, actors, and directors, commentary, bloopers, behind the scenes footage, outtakes, remixes, and similar kinds of content. Users often value these extra features and find them as an appealing way to learn more about the media content. Such features can be expected to be available for both audio and video content.

The rich metadata 515 can also include live feeds that reflect current or dynamically changing information such as concert dates or news items about an artist, band, or actor. Additional interfaces or portals to enable purchasing of related items such as concert tickets or merchandise tie-ins may also be supported.

Casual users of the service 105 may be expected to find the rich metadata 515 as an easy way to access resources that offer fun and interesting supplements to the media content. More sophisticated users will typically find their needs met by the depth and breadth of the additional related information that they might not be able to find from other resources. For example, media content owners might agree, as part of their agreements with the provider of the service 105, that certain related information or extra features be exclusively available on the service.

The remaining factors shown in FIG. 5 are generally related to the commercial context in which the service 105 operates. The terms of service factor 520 will typically take into account the business model used by service 105. In this example, a virtual jukebox is contemplated as being rented so that the targeted content is not owned by the user 105. A set of DRM rights are associated by the service 105 with a package of music or media and the user's PC 109 and player 125 will play back the music in accordance with those rights. Specifically, the service 105 will create a package that is themed or is otherwise attractive to a user 120 to rent on a limited basis, such as for an event, special occasion or other happening which occurs over a limited time period. By creating limited time packages to be used for limited time events, the service 105 can offer a new model for accessing media to users that currently does not exist.

In one embodiment, a media package could be a “'70s music party”. Here, the service 105 would identify media relevant to that theme, and create a jukebox package for the user 120. The user 120 when browsing the service 105 may be having an event at home or elsewhere that would be enhanced by access to that particular themed package. Since the event will be taking place for a limited time, e.g. an evening, the limited time restriction would not be objectionable to the user. In addition, because the event is an ephemeral occasion, the user is typically not also expecting to own the music. Therefore, this model removes the current objections users often have to renting music in a monthly subscription model, because they have less expectations of owning music that is heard at an event. Another significant advantage of this new service is that the users can take the virtual jukebox anywhere they can take their player 125, as long as they can bring or access speakers.

More specifically, the invention allows a whole new type of targeting: event-based targeting, due to the creation and enforcement of limited time DRM models. In this embodiment, the service 105 creates packages of music or media associated with events, and then creates more particular targeted packages for themed events. The service 105 can create a first hierarchy, where a set of media is associated with high level events, such as birthdays, weddings, sporting events, and the like. The service 105 can then sub-target media for themed events, such as “'80s birthday” or “'70s Dance Party” or “Rock and Roll Football Tailgate” or “Jazz Wedding”. These events could even be further sub-targeted, such as “'80s Electronica Dance Party”, and so forth.

The service 105 can create as many tiers of targeting as seem attractive to a user 120. Since the packages are stored at the service 105, a virtually unlimited number of packages can be created, increasing the likelihood that something will be found that suits the specific tastes of the user 120. In one embodiment, the time limitation can be adjusted based on the event. For example, an event can be a road trip, and the service 105 then creates a DRM time period that will allow access for a week or a weekend, or other appropriate time period. In this model, the user can listen to the themed music while driving to their destination and back, and the expiration of their rights will not occur until after the trip is over. Different road trip themes can be created for differing musical tastes. In a further embodiment, the service 105 dynamically allows the user to set the DRM-enforced time period. In this model, the user 120 may pay a fee-per-day to extend access to the package, or create an initial time period that is more suitable to his needs.

This model further allows the user 120 to customize the access period, and ensures the service 105 and the content providers that they are properly paid for the access. This embodiment typically requires the DRM enforcement of the service 105 to be adjustable. For example, the time value of the license is not set until the payment authorization is received, and then the selected time period value is added to the license, which is then enforced by the PC 109 or player 125. In some embodiments, a maximum time that a user can extend to is enforced. This maximum time enables the content providers to limit access to their content. In another embodiment, if a user pays a sufficient amount of money, the user may be given rights or a discount toward purchasing all of the songs in the package. In a further embodiment, the user may be given the ability to credit payments to one or more songs in the package, which the user can select.

In addition, although the above description focuses on music, other media could be themed and rented as a package. Multiple types of media could be combined together for a package. In one embodiment, a package of media could be created for a slumber party, and would include music appropriate to the particular age group, and movies appropriate to the specific age group. Again, the limited nature of the event makes it more likely that the users 120 will be comfortable obtaining only limited non-ownership rights.

Another advantage of the current model is the ability to later access and purchase the music heard at the event. In one embodiment the player 125 or the PC 109 record the metadata of the music or media played during the event and store it in a library. After the event, and even after the expiration period, the user 120 can access the library to view the songs or media played. The user 120 can then purchase any of the songs played merely by selecting a purchase option. The purchase option causes the player 125 or PC 109 to access the service 105 to obtain purchase rights to the song, which can then be downloaded to the player 125. In addition, if a user is consistently using jukebox packages, the user 120 may decide to obtain a monthly subscription, which could eliminate or reduce the package rental fee. The rental fee can vary by implementation, but will generally be selected so that users perceive the fee as being appropriate to the value received. For example, a $4.00 rental fee could allow unlimited plays of a virtual jukebox having 100 songs over a weekend. In addition, it will be often desirable to set the rental fee at a point to encourage users to try new targeted content that they might otherwise be reluctant to purchase outright.

If advertising is utilized it may be dynamically inserted, for example, into a targeted content as it is generated.

The license restriction factor 525 (which may include accommodation for various DRM schemes) may also be considered when programming media content into a virtual jukebox 412. For example, depending on the terms of the agreements that are in place between the provider of the service 105 and the owners of the media content used in the virtual jukeboxes 412, there could be restrictions imposed on the number of virtual jukeboxes that a given user may rent at one time.

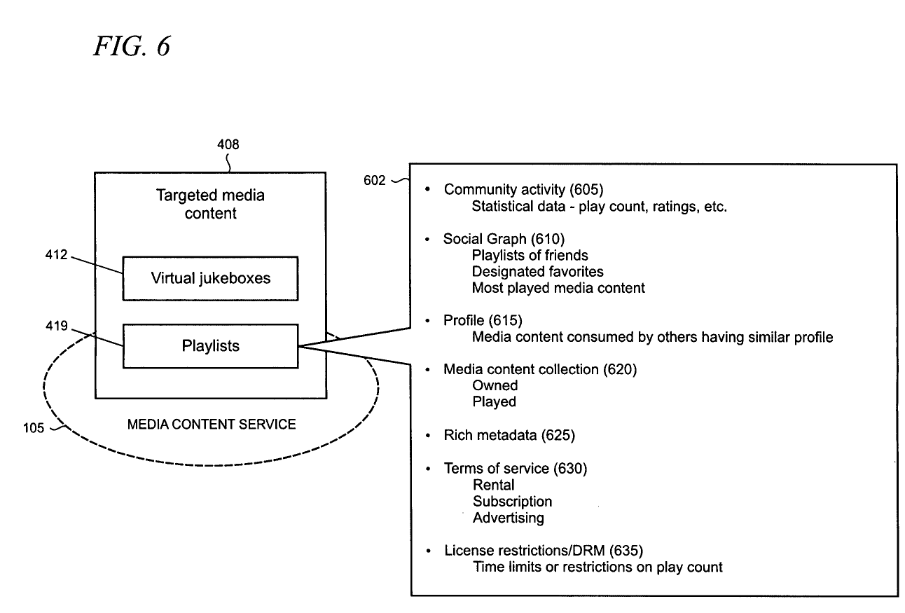

FIG. 6 shows a variety of factors 602 that may be utilized to create targeted content in the form of playlists. As in the above example, the factors shown are intended to be illustrative and can be weighted in different ways to meet the needs of a particular implementation as appropriate. It is also not necessary that all the factors shown in FIG. 6 be used in all implementations of the present media content service.

The activity among the community of users of the service 105, along with the activities of the specific users and those within the user's social graph will form a basis for creating playlists that are customized for a given user. More specifically, the community activity 605 will typically comprise statistical data that is collected by the service 105 with regard to various usage attributes that are associated with particular pieces of media content. Such statistics could include, for example, the overall play count of the songs that are provided by the service 105, ratings of the songs that are collected as user-feedback, and other data that is collected from the community of service users as a whole.

The social graph factor 610 takes into account the activities of other people who use the service 105 who are identified as being within the user's social graph. Typically, the user will identify friends or be identified by others as a friend, or have some other connection or relationship that can be identified. Thus, the user's social graph could extend to people who have expressed common interests in music or film genres, or who may be members of the same artist fan club that is hosted by the service 105. So, for example, the social graph factor 610 can include those songs that are being listened to by the user's friends, the favorite songs of friends, which songs are most played by friends, and so on.

The profile factor 615 considers the profile of the user and looks to media content that is consumed by other users of the service 105 having similar profiles. A user profile will commonly consider demographic information such as age, gender, education, residency, hobbies/interests, and similar factors that may be furnished by the user, either as part of a service sign-up process, or that are explicitly provided to help the service 105 program the playlist.

Assuming permission is received to do so, the media content collection factor 620 looks to the types and genres of media content that the user either owns (for example, music stored on the hard disk 310 on PC 109), or the media content that the user plays (either through the service 105, or via other sources such as Internet radio, for example) but does not own. The user's collection of media content can often be expected to provide a good basis for programming because similar artists and genres to those in the collection can often be readily identified.

As with the example shown in FIG. 5 and described in the accompanying text, rich metadata 625 may be optionally provided so that the user may see and interact with a variety of information that is associated with any of the media content contained in a playlist 419. The targeted content in a playlist in this example is also subject to a rental model under the terms of service 630 (although other business models may also be utilized). In one example, the user 120 may download a playlist 419 of a friend containing 100 songs and play the playlist an unlimited number of times over a period of a month for a subscription fee of $4.00. Next month, the user 120 can download a playlist of another 100 songs for the same subscription fee.

The license restriction factor 635 (which may include accommodation for various DRM schemes) may also be considered when programming media content into a playlist 419. For example, in a similar manner as with the virtual jukeboxes 412, depending on the terms of the agreements that are in place between the provider of the service 105 and the owners of the media content used in the playlists 419, there could restrictions imposed on the number of playlists that a given user may rent at one time.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for programming media content into a playlist for online delivery by a service to a remote client, the method comprising the steps of:
collecting statistics pertaining to a community of users of the service, the statistics including identity of media content and associated consumption by the community of users in the form of playlists of media content;
collecting information that is specific to a user, the information comprising at least a social graph of the user;
generating one or more customized playlists for the user by selecting media content for inclusion into the playlist responsively to the statistics and information; and
delivering the one or more customized playlists to the remote client via an online interface, the delivering being subject to terms of use between the user and the service.

2. The method of claim 1 including a further step of providing data to a user interface on the remote client, the data being usable to enable the user to browse and make selections among the one or more customized playlists.

3. The method of claim 1 in which the terms of use support at least one of advertising-based business model, subscription-based business model, or playlist rental model.

4. The method of claim 1 in which the terms of use impose restrictions on rendering of media content in the one or more customized playlists by play count or by time.

5. The method of claim 4 in which the restrictions are enforced using a DRM system that is operable on the remote client.

6. The method of claim 1 including a further step of providing metadata associated with the media content in the playlist to the client via the online interface.

7. The method of claim 6 including a further step of configuring the metadata to include information pertaining to at least one of artist, album, group, album artwork, production, composer, label, lyrics, liner notes, interviews, discographies, remixes, alternative versions, commentary, reviews, ratings, or dedications.

8. The method of claim 6 including a further step of configuring the metadata to include information pertaining to at least one of actor, director, producer, studio, outtakes, bloopers, alternative endings, director cuts, special editions, unrated versions, interviews, commentary, reviews, ratings, making of documentaries, behind-the-scenes footage, or deleted scenes.

9. A method for programming media content into pre-packaged virtual jukeboxes for online delivery by a service to a remote client, the method comprising the steps of:
pre-packaging a plurality of pieces of media content targeted for an event into each of the virtual jukeboxes;
providing data associated with the virtual jukeboxes on the remote client, the data being usable to enable the user to browse and make selections among the virtual jukeboxes; and
delivering the selected ones of the virtual jukeboxes to the remote client via an online interface, the access of which being subject to a limited time rental period.

10. The method of claim 9 in which the event targeting focuses on an activity.

11. The method of claim 10 in which the event targeting associates media relevant for one of birthday, party, or wedding event.

12. The method of claim 9 in which the access includes an advertising-based business model.

13. The method of claim 12 including a further step of providing a portal to a facility for effectuating the rental.

14. The method of claim 9 in which the terms of use impose restrictions on rendering of media content in a virtual jukebox by play count or by time.

15. The method of claim 9 in which the remote client is one of PC, game console, set-top box, or network access point.

16. The method of claim 9 in which the media content comprises one of audio or video, the audio being selected from a group consisting essentially of music, audio book, podcast, news, or commentary, the video being selected from the group consisting essentially of television program, music video, video clip, movie, or feature film.

17. A computer-readable medium containing instructions which, when executed by one or more processors disposed in an electronic device, implement a client arranged for interacting with media content received from a service, the client performing a method comprising the steps of:
implementing a user interface arranged to enable a user to browse and select from media content in a form of one or more playlists or virtual jukeboxes, the one or more playlists or virtual jukeboxes being programmed by the service for targeting the media content to users of the service;
receiving selected playlists, the receiving subject to terms of use; and
transferring the received one or more playlists or virtual jukeboxes to a portable electronic device that is configured for rendering media content, the rendering subject to the terms of use.

18. The computer-readable medium of claim 17 in which the terms of use comprise payment of a rental fee and restrictions on rendering of the playlists or virtual jukeboxes, the restrictions being one of limited play count or limited time for playback.

19. The computer-readable medium of claim 17 in which the targeting includes generating playlists that are selected using a social graph associated with the user or creating virtual jukeboxes in which the media content is associated by genre or associated with one of style, fashion, trend, or cultural element.

20. The computer-readable medium of claim 17 in which the portable electronic device is one of PDA, smart phone, mobile phone, personal media player, MP3 player, multimedia player, handheld game device, or handheld computer.
